(19) United States
(12) Patent Application Publication
(10) Pub. No.: US 2023/0264838 A1
(43) Pub. Date: Aug. 24, 2023

(54) MULTIPURPOSE AND LONG ENDURANCE HYBRID UNMANNED AERIAL VEHICLE

(71) Applicant: UCAL FUEL SYSTEMS LIMITED, Tamil Nadu (IN)

(72) Inventors: Padmanabhan MYOOR KANDHADAI, Tamil Nadu (IN); Gajendran CHANDRAN, Karnataka (IN); Dinesh MANOHARAN, Tamil Nadu (IN); Satheesh CHANDRAMOHAN, Pondicherry (IN); Mohammed Tharik FALEEL DEEN, Pondicherry (IN); Vignesh SUNDARAMOORTHY, Tamil Nadu (IN); Rajesh SANKARAN, Tamil Nadu (IN)

(21) Appl. No.: 18/012,376

(22) PCT Filed: Jun. 23, 2021
(86) PCT No.: PCT/IN2021/050608

§ 371 Date: Dec. 22, 2022

(30) Foreign Application Priority Data
Jun. 26, 2020 (IN) 202041027201

(51) Int. Cl. B64U 10/20; B64U 10/25; B64C 29/00; B64U 50/13; B64U 60/10; B64D 1/18; B64D 27/24; B64C 25/54; B64C 35/00; B64U 50/31; G05D 1/10

(52) U.S. Cl. CPC B64U 10/20; B64U 10/25; B64C 29/0025; B64U 50/13; B64U 60/10; B64D 1/18; B64D 27/24; B64C 25/54; B64C 35/00; B64U 50/31; G05D 1/102; B64U 2101/30

(57) ABSTRACT

The present invention relates to a multipurpose and long endurance Hybrid Unmanned Aerial Vehicle (HUAV) with the combined functions of a Vertical Take-off and Landing (VTOL) and a fixed wing operation. The HUAV may take-off and land vertically on both land and water, and perform a mid-air transition from a VTOL mode to a fixed wing mode. The HUAV includes an airframe, a fixed wing unit having at least one forward thrust motor, one or more VTOL units mounted on a tail boom, and a fuselage of the airframe. Each of the one or more VTOL units includes at least one VTOL motor, and a control unit configured to control on-board transition of the HUAV between the VTOL mode and the fixed wing mode by controlling at least one forward thrust motor and at least one VTOL motor.

### FIELD OF THE INVENTION

The present invention relates generally to unmanned vehicles, and more specifically, to a multipurpose and long endurance hybrid unmanned aerial vehicle having amphibious capabilities.

### BACKGROUND

An unmanned vehicle (also commonly referred to as an autonomous vehicle) is a vehicle capable of travel without a physically present human operator. Conventional unmanned fixed rotor aerial vehicles belong to one of two categories: Vertical Take-off and Landing (VTOL) aerial vehicles or fixed wing aerial vehicles. A VTOL aerial vehicle generates lift by propelling air below itself, thereby eliminating the need for a runway or launching mechanism to take off. VTOL multi-copters employ rotors, which produce downward thrust to hover at the expense of speed and efficiency, which are characteristic of the second fixed rotor category, the plane. Conventionally, fixed wing aerial vehicles produce thrust in the horizontal axis and use wings to generate lift. As a result, conventional fixed wing aerial vehicles require a runway or launching mechanism to launch. Once airborne, fixed wing aerial vehicles, expend significantly less energy on staying airborne, whereas a VTOL aerial vehicle loses a constant stream of energy to maintain altitude.

Various types of unmanned vehicles exist for various different environments. For instance, unmanned vehicles exist for operation in the air, on the ground, underwater, and in space. Unmanned vehicles also exist for hybrid operations in which multi-environment use is possible. Examples of hybrid unmanned vehicles include an amphibious craft that is capable of operation on land as well as on water or a floatplane that is capable of landing on water as well as on land.

In various fields of technology, there is a requirement for devices, which are capable of catering to applications such as inspection, reconnaissance, survey and transportation. For instance, in the field of telecommunication there is a significant need in providing remote network during natural disasters for long duration. Also, it is of paramount importance to cater to various applications of Pipeline Industry, Power line Industry, Railway Industry, Wind turbine Industry, Mining Industry, Construction sector, Agriculture sector, Research sectors, and Defence sectors, such as, monitoring of pipeline's integrity, inspection of damages on conductor lines and transmission towers, inspection of cracks on railway tracks, monitoring of large scale wind turbines, carrying out mineral surveys, mapping and surveying huge landscape and water bodies for constructing structures including buildings and dams, monitoring of crop health, studying and analysing water quality of remote water bodies and performing surveillance for counter terrorism.

However, such applications require extensive manual intervention and are impossible to complete within a short time period through use of conventional techniques. Furthermore, cost associated with such tasks drastically increases when conventional techniques are employed. Also, such tasks call for high safety protocols to be in place.

There is therefore a need in the art to overcome the above mentioned deficiencies associated with conventional techniques/devices by providing a vehicle capable of exhibiting long endurance and high versatility.

### OBJECTS OF THE INVENTION

An object of the present invention is to provide a hybrid unmanned aerial vehicle (HUAV) capable of exhibiting an autonomous operation for applications, such as, crop health monitoring, water sampling, fluid dispensing/spraying, remote network, research, reconnaissance, swarm operation, and the like.

Another object of the present invention is to provide a HUAV which is capable of performing long endurance, multi-terrain and multifunctional applications.

Another object of the present invention is to allow hybridization of a Vertical Take-off and Landing (VTOL) unit and a fixed wing UAV unit for preventing the requirement of large take-off distance and to provide flight operation at various terrains.

Another object of the present invention is to provide a HUAV powered by a hybrid power system coupled with solar energy, fuel cell, lithium-polymer battery system and the like sources of power.

Another object of the present invention is to provide a HUAV having amphibious capabilities for taking-off and landing in both land and water.

### SUMMARY OF THE INVENTION

The present invention relates to a hybrid unmanned aerial vehicle (HUAV) for multifunctional long endurance application such as assessment of agricultural land and crop health monitoring, pipeline and power transmission line monitoring, testing and analysing water quality on real-time basis, providing remote network and navigation system, research sectors, continuous surveillance, scouting in defence sectors, and the like.

The HUAV includes an airframe, a fixed wing unit having at least one forward thrust motor, one or more Vertical Take-off and Landing (VTOL) units mounted on a tail boom and a fuselage of the airframe, each of the VTOL units comprising at least one VTOL motor, and a control unit configured to control on-board transition of the HUAV between a VTOL mode and a fixed wing mode by controlling the at least one forward thrust motor and the at least one VTOL motor.

According to an embodiment of the present invention, the fixed wing unit includes an array of solar cells installed on top surface of a wing of the airframe.

According to an embodiment of the present invention, the at least one forward thrust motor is coupled with at least one propeller and at least one electronic speed controller, the at least one forward thrust motor being disposed to a rear side of the fuselage.

According to an embodiment of the present invention, the at least one VTOL motor is coupled with at least one propeller, at least one brushless DC motor, at least one electronic speed controller, and at least one battery pack, the at least one VTOL motor being operationally coupled with the airframe.

According to an embodiment of the present invention, the control unit is configured to control rotational speed of the propellers by controlling the at least one VTOL motor and the at least one forward thrust motor, for providing a gradual transition between the VTOL mode and the fixed wing mode.

According to an embodiment of the present invention, the HUAV further includes a plurality of payloads mounted on the airframe and at least one landing gear having a plurality of floats attached thereto to enable amphibious operation of the HUAV. According to an embodiment of the present invention, the plurality of payloads include one or more multi-spectral cameras and at least one first person view (FPV) camera. According to another embodiment of the present invention, the plurality of payloads include a spraying unit adapted to dispense a material over a geographical area.

According to an embodiment of the present invention, the HUAV includes a swarm communication unit configured to control communication between the HUAV and a plurality of other Unmanned Aerial Vehicles (UAVs) through any of Radio Frequency (RF) and LTE communication networks.

According to an embodiment of the present invention, the HUAV includes a hybrid power supply unit having at least a battery power source, a fuel cell and a solar power supply.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an isometric view representation of a Hybrid Unmanned Aerial Vehicle (HUAV) in accordance with an embodiment of the present invention;

FIG. 2A illustrates an exemplary front view representation of the HUAV in accordance with an embodiment of the present invention;

FIG. 2B illustrates an exemplary side view representation of the HUAV in accordance with an embodiment of the present invention;

FIG. 2C illustrates an exemplary top view representation of the HUAV in accordance with an embodiment of the present invention;

FIG. 2D illustrates an exemplary representation of the HUAV in accordance with an embodiment of the present invention; and

FIG. 3 illustrates an exemplary representation of flight control system of the proposed HUAV in accordance with an embodiment of the present invention.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described in more detail hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The present invention relates to a Hybrid Unmanned Aerial Vehicle (also referred to as “HUAV” hereinafter) which is capable of catering to both Vertical Take-off and Landing (VTOL) and fixed wing operations. The HUAV is also capable of being airborne and landing on both land and water and may perform mid-air transition from VTOL mode to a fixed wing mode.

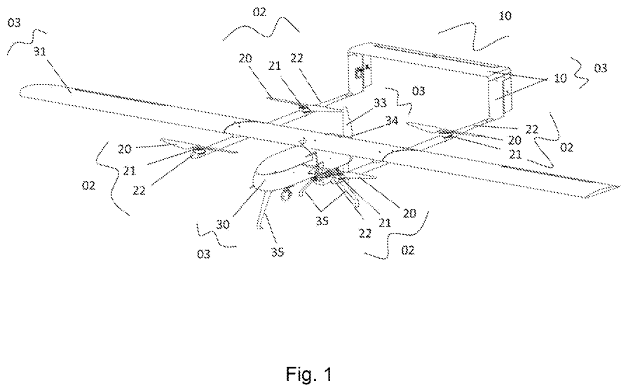

FIG. 1 illustrates an isometric view representation of the proposed Hybrid Unmanned Aerial Vehicle (HUAV) in accordance with an embodiment of the present invention. The HUAV (10) includes an all-terrain airframe having a fuselage (30), a wing (31) and an empennage (43), a fixed wing unit (03), and a plurality of Vertical Take-off and Landing (VTOL) units (02) mounted on any of tail boom (22) and fuselage (30) of the airframe. A plurality of payloads (41) may be mounted on the airframe and a landing gear (35) may be coupled to the airframe.

According to an embodiment of the present invention, the twin boom empennage (32) is attached on the tail boom (22) that is attached underneath the wing section of the HUAV (10).

According to an embodiment of the present invention, the payloads (41) may include one or more multi-spectral camera, a thermal camera and at least one first person view (FPV) camera mounted on the airframe. According to an embodiment of the present invention, the fuselage (30) may be designed in such a way to accommodate various payloads (41) such as, but not limited to, a high resolution camera, a multi-spectral camera, relief utilities, a LIDAR system, spraying units, network provider, and the likes. In an embodiment, a dedicated payload bay is designed to accommodate any kind of payload (41) within an allocated space of the HUAV (10).

According to an embodiment of the present invention, the HUAV (10) may be provided with a Light Detection and Ranging (LIDAR) system to prevent collisions and accidents in order to ensure a safe and level flight. Further, the HUAV (10) may be equipped with a first person view camera to transmit live video feedback to a ground station. According to an embodiment of the present invention, the HUAV (10) may contain an on-board data analysing unit which may analyse data simultaneously during flight of the HUAV and may transmit the live flight data through RF communication to the ground station.

According to an embodiment of the present invention, the HUAV (10) may carry payloads including a multi-spectral camera capable of sensing reflectance of the region. Based on the detected spectrum of light, crop health and water quality may be assessed and suitable mitigation procedures like spraying pesticides on the infected areas and collecting water samples to research about the quality of water may be carried out. The multi-spectral camera may be a high resolution camera which is used for surveying and scouting geographical locations.

According to an embodiment of the present invention, the payloads (41) may include a spraying unit, which allows dispensing of materials, such as, pesticides over crops in agricultural applications.

According to an embodiment of the present invention, the HUAV (10) may further include a hybrid power supply unit having any or a combination of a battery power source, a fuel cell and a solar power supply. The solar power is generated from the array of solar cells installed on the top surface of the wing (31) which are used to power up the forward thrust motor (34) during cruise condition. The hybrid power supply of the HUAV (10) provides continuous power to various components of the HUAV (10) for prolong endurance flight operations which makes the HUAV (10) to function as a long endurance and versatile aerial vehicle which is capable of catering to amphibious applications.

According to an embodiment of the present invention, in case of lack of sunlight or during cloudy conditions, the power supply unit allows the forward thrust motors (34) to operate from power supply of the battery power source or power generated from the fuel cell. According to an embodiment of the present invention, the VTOL motors (21) may be powered by the battery power source, which may be a Lithium-Polymer (LiPo) battery.

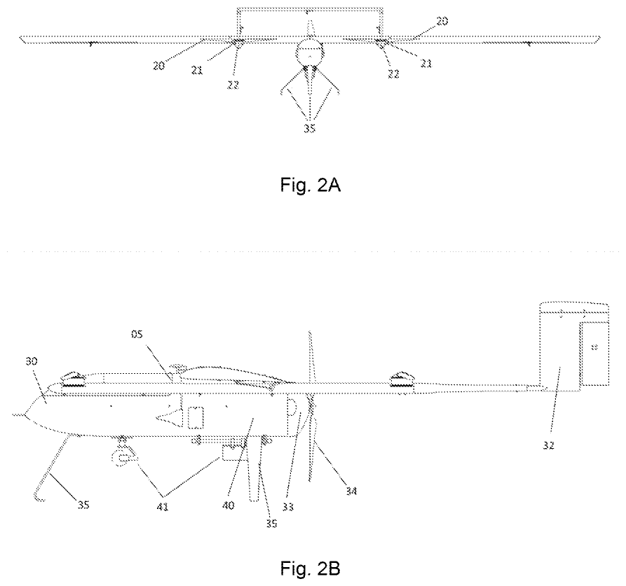

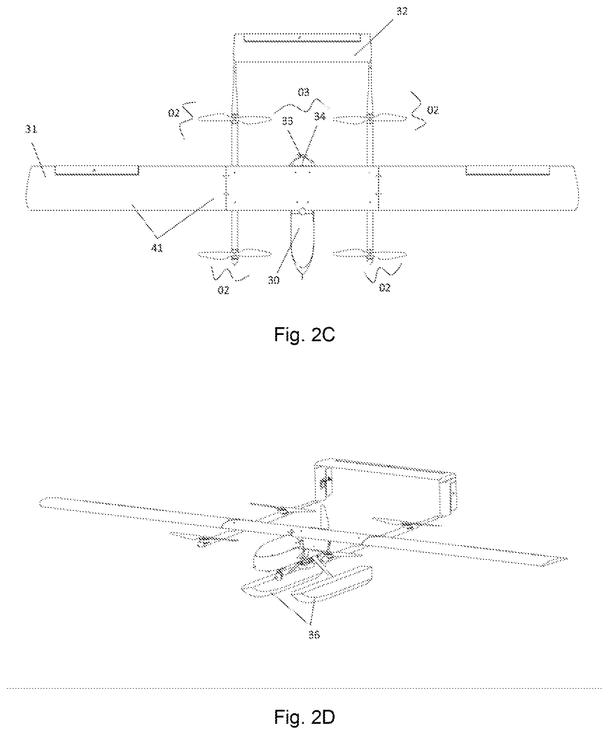

Referring now to FIGS. 2A-2C which illustrate exemplary front view, side view and top view representations of the HUAV (10) in accordance with an embodiment of the present invention, respectively.

According to an embodiment of the present invention, the airframe of the HUAV (10) may be made up of advanced composite material having damp resistant and water resistant properties which is capable of withstanding unbalanced forces and vibrations during flight operation of the HUAV (10) in order to providing stability during flight of the HUAV (10).

According to an embodiment of the present invention, the VTOL unit (02) may include a plurality of propellers (20), brushless DC motors (also referred to as “VTOL motors” hereinafter) (21) coupled with the tail booms (22) of the airframe, electronic speed controllers, and one or more battery packs. The plurality of VTOL motors (21) connected with the propellers (20) may rotate at high rotational speed to provide the thrust required for vertical take-off of the HUAV (10), which may assist the HUAV (10) in getting airborne and achieve a desired cruise altitude within less time interval.

According to an embodiment of the present invention, the fixed wing unit (03) of the HUAV (10) may include at least one forward thrust motor (34), one or more propellers (33), an electronic speed controller and a battery pack (40) to enable flight of the HUAV (10). The at least one forward thrust motor (34) with the one or more propellers (33) and the electronic speed controller may mounted to a rear side of the fuselage (30).

According to an embodiment of the present invention, once the HUAV (10) reaches its cruise altitude, the transition between VTOL motors (20) and forward thrust motor (34) occurs gradually. The forward thrust motor (34) connected with propeller (33) attached on the rear side of the fuselage starts rotating, thereby providing a necessary thrust to generate the lift in the fixed wing unit. During this transition, the VTOL motors (21) rotate to provide stability to HUAV (10) until it achieves a specific cruise velocity.

According to an embodiment of the present invention, an array of solar cells may be installed on top surface of the wing (31) of the airframe to provide solar energy to battery packs of the VTOL units (02) and the fixed wing unit (03). A solar power converter may be coupled with the fuselage (30) of the airframe to control sufficient supply of electric power to the battery packs of the VTOL unit (02) and the fixed wing unit (03).

According to an embodiment of the present invention, the HUAV (10) may have a primary user interface which accepts input flight path and GPS coordinates remotely through wireless communication in order to allow flight operations of the HUAV (10) to be controlled and managed autonomously without any manual intervention.

According to an embodiment of the present invention as shown in FIG. 2D, the landing gear (35) of the HUAV (10) may act as a platform for attaching a plurality of floats (36), which enable continuous flight operation of the HUAV (10) in both land and water, thereby making the HUAV (10) an amphibious vehicle. This amphibious capability of the HUAV (10) extends its application in various water-based domains such as, water quality assessment in remote water bodies, seashore monitoring, oceanic research, flood, tsunami reliefs, and the likes.

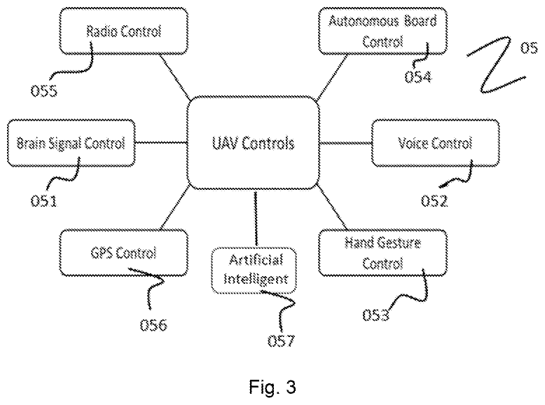

FIG. 3 illustrates an exemplary representation of flight control system of the proposed HUAV in accordance with an embodiment of the present invention. According to an embodiment of the present invention, the flight control system may control flight operations such as landing, take-off and transition between VTOL mode and fixed wing mode of the HUAV. The flight control system may include a control unit (05) which controls flight operations of the HUAV.

According to an embodiment of the present invention, the control unit (05) may include an avionic unit which is capable of providing on-board transition of the HUAV from VTOL mode to fixed wing mode by controlling motors of the VTOL unit (02) and the fixed wing unit (03) of the HUAV. According to an embodiment of the present invention, the control unit (05) may control speed of rotation of the propellers by controlling rotation of the motors of the VTOL unit (02) and the fixed wing unit (03) of the HUAV, for allowing a gradual transition between the VTOL mode and the fixed wing mode, or vice versa.

According to an embodiment of the present invention, the control unit (05) may generate necessary instructions pertaining to transition of flight of the HUAV (10) from VTOL mode to fixed wing mode. According to an embodiment of the present invention, the control unit (05) may be integrated with a plurality of avionic sensors to enable fully autonomous flight operations of the HUAV (10).

According to an embodiment of the present invention, the control unit (05) may be in communication with a plurality of avionic sensors and a communication port which enable controlling of flight operations of the HUAV (10) through Brain control, Voice control, Hand motion control, Autonomous board control, Remote/radio control and Global Positioning System (GPS) control which may allow communication of the HUAV (10) with a ground control station (GCS). The control unit (05) and the GCS may communicate with each other using data communication units which may include a communication unit that transmits command and data to the HUAV (10) and transmits the data received from the HUAV (10) to the GCS. According to another embodiment of the present invention, the communication unit may transmit command and receive data from the payloads of the HUAV (10). The communication unit may be facilitated by Radio Frequency (RF) or a Long-Term Evolution (LTE) communication networks for communication with any or a combination of the HUAV (10) or its payloads. Thus, the HUAV (10) may be controlled using a Radio controller (RC) and/or a smartphone, tablet and other LTE based devices.

According to an embodiment of the present invention, the control unit (05) may include a Brain signal control unit (051), a Voice control unit (052), a Hand motion control unit (053), Autonomous board control unit (054), a Remote/Radio control unit (055), a GPS control unit (056), and an Artificial Intelligent control unit (057). The brain signal control unit (051) may have an Electroencephalogram (EEG) signal reading head band that gets raw signal from brain of a user and produces an analog output which is converted to digital signal using an analog to digital converter. The signal is amplified and fed as an input to a microprocessor/computer that processes the digital signals using sophisticated algorithms (feature extraction and translation) and outputs/sends the respective commands to the flight control unit (05).

According to an embodiment of the present invention, the hand motion control unit (053) uses hand gestures/finger movement for providing commands to the flight control unit (05). A flex sensor hand glove may be used to determine the movement or gesture from hand of a user which corresponds to a specific predefined command.

According to an embodiment of the present invention, the autonomous board control unit (054) (also referred to as “autopilot system” hereinafter) is the central processing unit of the UAV. The autopilot system (054) may have a control board with a microprocessor, an inbuilt IMU sensor, compass, etc., and some external sensors for estimating the state of the UAV. With user given inputs or limitations and feedback from the sensors the autonomous board control unit (054) controls and commands the UAV accordingly.

According to an embodiment of the present invention, the GPS control unit (056) is a module that gets GPS coordinates from satellites. The GPS control unit (056) works along with the autonomous board control unit (054) for navigation of the UAV.

According to an embodiment of the present invention, the Artificial Intelligence control unit (057) is a device (a companion computer to the flight control unit) which uses machine learning algorithms to command and operate the UAV without any kind of human intervention. In an embodiment, when using multiple UAVs, the AI system on each of the UAVs can communicate with each other and operate as a swarm of UAVs.

According to an embodiment of the present invention, the Remote/Radio control unit (055) may allow the control unit (05) of the HUAV (10) to be controlled/regulated from a remote location. The Remote/Radio control unit (055) may use transceivers installed at specific locations of the HUAV (10) and at a remote location which may communicate wirelessly through Radio-frequency transmission. The Remote control unit (055) may allow transmission of data between the control unit (05) of the HUAV (10) and a remote controller installed at the remote location to enable unmanned flight of the HUAV (10) to be controller by the remote controller.

According to an embodiment of the present invention, the control unit (05) may be configured so as to allow the HUAV (10) to operate in multiple flight operation modes to reach a target location. The control unit may allow the HUAV (10) to choose an airborne route depending on user's preferred settings and/or amount of electrical energy stored in battery packs and environmental factors.

According to an embodiment of the present invention, the control unit (05) may be coupled with a swarm communication unit configured to control communication between the HUAV and a plurality of other Unmanned Aerial Vehicles (UAVs) through any of RF and LTE communication networks.

According to an embodiment of the present invention, the control unit (05) may be fully autonomous or semi-autonomous or fully manual or semi-manual as per end user requirement and may further include microprocessor(s), accelerometer(s), gyroscope(s), magnetometer/GPS and a barometer for sensing the flight conditions and aid in the autonomous operation of the HUAV (10).

According to an embodiment of the present invention, the control unit (05) may be operatively coupled with high level safety systems including an automatic recovery system which has a capability of returning the HUAV to a home location without any manual intervention, and an emergency parachute system adapted to be deployed when there is an unexpected functional failure in flight system of the HUAV to safely descend the HUAV (10) to the ground without crashing.

According to an embodiment of the present invention, the control unit (05) may be operatively coupled with an advanced avionic system which allows the HUAV (10) to follow necessary protocols in case of identification of anomalies during reconnaissance using commands through Artificial Intelligence (AI) and machine learning.

Thus, the present invention relates to a hybrid unmanned aerial vehicle which has combined functions of a Vertical Take-off and Landing and a fixed wing operations, and has an ability to take-off and land vertically on both land and water and perform mid-air transition between VTOL mode and fixed wing mode. The HUAV is adapted to carry a plurality of payloads within an allocated space of the HUAV. Landing gear of the HUAV acts as a platform for attaching a plurality of floats for allowing amphibious operation of the HUAV by enabling continuous flight operation in both land and water. This amphibious capability of the proposed HUAV extends the application of the HUAV in various water as well as land based domains like assessment of agricultural land and crop health monitoring, pipeline and power transmission line monitoring, testing and analysing water quality on real-time basis, providing remote network and navigation system, research sectors, continuous surveillance, scouting in defence sectors, seashore monitoring, oceanic research, flood and tsunami reliefs. The HUAV performs the abovementioned applications autonomously using high end processing boards, avionics systems and sensors.

In the above detailed description, reference is made to the accompanying drawings that form a part thereof, and illustrate the best mode presently contemplated for carrying out the invention. However, such description should not be considered as any limitation of scope of the present unit. The structure thus conceived in the present description is susceptible of numerous modifications and variations, all the details may furthermore be replaced with elements having technical equivalence.

### ADVANTAGES OF THE INVENTION

The present invention provides a hybrid unmanned aerial vehicle (HUAV) capable of exhibiting an autonomous operation for applications, such as, crop health monitoring, land/water body survey and mapping, water sampling, fluid dispensing/spraying, remote network, research, reconnaissance, swarm operation, and the like.

The present invention provides a HUAV which is capable of performing long endurance, multi-terrain and multifunctional applications.

The present invention allows hybridization of a VTOL unit and a fixed wing UAV unit for preventing the requirement of large take-off distance and to provide flight operation at various terrains.

The present invention provides a HUAV powered by a hybrid power system coupled with solar energy, fuel cell, lithium-polymer battery system and the like sources of power.

The present invention provides a HUAV having amphibious capabilities for taking-off and landing in both land and water.

We claim:

1. A hybrid unmanned aerial vehicle (HUAV) designed for long endurance applications comprising:
an airframe;
a fixed wing unit having at least one forward thrust motor;
one or more Vertical Take-off and Landing (VTOL) units mounted on the airframe, where each of the one or more VTOL units comprises at least one VTOL motor; and
a control unit configured to control on-board transition of the HUAV between a VTOL mode and a fixed wing mode by controlling the at least one forward thrust motor and the at least one VTOL motor.

2. The HUAV as claimed in claim 1, wherein the fixed wing unit comprises an array of solar cells installed on a top surface of a wing of the airframe.

3. The HUAV as claimed in claim 1, wherein
the at least one forward thrust motor is coupled with at least one propeller and at least one electronic speed controller, and
the at least one forward thrust motor is disposed to a rear side of a fuselage.

4. The HUAV as claimed in claim 1, wherein
the at least one VTOL motor is coupled with at least one propeller, at least one electronic speed controller, and at least one battery pack, and
the at least one VTOL motor is coupled with the airframe.

5. The HUAV as claimed in claim 3, wherein the control unit is configured to:
control rotational speed of the at least one propellers by controlling the at least one VTOL motor and the at least one forward thrust motor and
provide a gradual transition between the VTOL mode and the fixed wing mode.

6. The HUAV as claimed in claim 1, further comprising:
a plurality of payloads mounted on the airframe; and
at least one landing gear having a plurality of floats attached thereto to enable amphibious operation of the HUAV.

7. The HUAV as claimed in claim 6, wherein the plurality of payloads comprises one or more multi-spectral cameras, a thermal camera and at least one first person view (FPV) camera.

8. The HUAV as claimed in claim 6, wherein the plurality of payloads comprises a spraying unit adapted to dispense a material over a geographical area.

9. The HUAV as claimed in claim 1, further comprising a swarm communication unit configured to control communication between the HUAV and a plurality of other Unmanned Aerial Vehicles (UAVs) through any of Radio Frequency (RF) and LTE communication networks.

10. The HUAV as claimed in claim 1, further comprising a hybrid power supply unit having at least a battery power source, a fuel cell and a solar power supply.

11. The HUAV as claimed in claim 4, wherein the control unit is configured to:
control rotational speed of the at least one propeller by controlling the at least one VTOL motor and the at least one forward thrust motor, and
provide a gradual transition between the VTOL mode and the fixed wing mode.
